(19) United States
(12) Patent Application Publication
(10) Pub. No.: US 2025/0065668 A1
(43) Pub. Date: Feb. 27, 2025

(54) DECORATIVE SECURITY WHEEL FASTENER

(71) Applicant: MACLEAN-FOGG COMPANY, Mundelein, IL (US)

(72) Inventors: Mark RAVES, Commerce Township, MI (US); Lee Richard MAYERS, Sterling Heights, MI (US); Joseph VERLA, Bloomfield Hills, MI (US); Kenneth James RIMATZKI, Harrison Township, MI (US)

(73) Assignee: MACLEAN-FOGG COMPANY, Mundelein, IL (US)

(21) Appl. No.: 18/727,058

(22) PCT Filed: Jan. 4, 2023
(86) PCT No.: PCT/US2023/010127

§ 371 Date: Jul. 5, 2024

Related U.S. Application Data
(60) Provisional application No. 63/315,434, filed on Mar. 1, 2022.
(60) Provisional application No. 63/296,422, filed on Jan. 4, 2022.

(51) Int. Cl. B60B 3/16; B60B 7/16; F16B 23/00; F16B 37/14

(52) U.S. Cl. CPC B60B 3/165; B60B 7/16; F16B 23/0007; F16B 37/14; B60B 2900/3318

(57) ABSTRACT

A security fastener assembly is provided with a cap having a decorative bearing surface and a lower retention portion. A fastener body has: a threaded portion or securing the fastener assembly to a corresponding threaded feature on a vehicle; a stem opposite the threaded portion for receiving the cap, the stem having a security protrusion defining a distal end, an undercut formed adjacent the stem for cooperating with the lower retention portion of the cap, where the lower retention portion of the cap is secured in the undercut to maintain the cap on the fastener body; a keyed security drive feature formed between the threaded portion the stem portion where the fastener body is removable with the keyed security feature. Engaging the decorative bearing surface of the cap and rotating does not rotate the threaded portion of the fastener body.

### CROSS-REFERENCE TO RELATED APPLICATIONS

This application claims the benefit of U.S. provisional application Ser. No. 63/296,422 filed Jan. 4, 2022, and U.S. provisional application Ser. No. 63/315,434 filed Mar. 1, 2022, the disclosures of which are hereby incorporated in their entirety by reference herein.

### TECHNICAL FIELD

The present disclosure relates to security wheel fasteners.

### BACKGROUND

Vehicle wheels are sometimes stolen for resale or scrap value. To prevent wheels from being stolen, a locking fastener may be used in the place of one of the standard wheel fasteners to “lock” the wheel to the vehicle and prevent removal of the fastener. These locking fasteners have a different appearance than the other decorative wheel fasteners on the same wheel and can be unattractive. One example of a decorative security fastener is discussed in International Application No. PCT/US20/66090 by Southwood et al.

### SUMMARY

In one embodiment, a security fastener assembly is provided having a cap and a fastener body. The cap has a standard tool bearing surface and a retention portion. The fastener body has a threaded portion for securing the fastener assembly to a vehicle. The fastener body has a stem opposite the threaded portion for receiving the cap and a retention feature formed adjacent the stem for cooperating with the retention portion of the cap. The fastener body has a keyed security drive feature to cooperate with a corresponding keyed tool. Engaging the tool bearing surface of the cap and rotating does not rotate the threaded portion of the fastener body. The fastener is rotatable and removable with the keyed security feature.

According to one other embodiment, a security fastener assembly is provided with a cap shaped with a standard tool bearing surface and a lower retention portion. A fastener body has: a threaded portion or securing the fastener assembly to a corresponding threaded segment on a vehicle; a conical stem opposite the threaded portion and defining a distal end, where the cap conceals the conical stem, an undercut formed below the conical stem and having a radius less than a base of the conical stem, where the lower retention portion of the cap is deformed inward into the undercut with a cold-working process to maintain the cap on the fastener body; and a keyed security drive feature formed between the threaded portion and the conical stem and not concealed by the cap for engagement by a corresponding security tool. Rotating the cap does not rotate the threaded portion of the fastener body, where the fastener body is removable from the corresponding threaded segment with the keyed security feature.

In another embodiment, the lower retention portion is swagged to deform the lower retention portion into the undercut continuously along at least a portion of the circumference of the undercut.

In another embodiment, the cold-working processes forms a plurality of retention locations that deform the lower retention portion into the undercut at each of the plurality of retention locations.

In another embodiment, the security fastener assembly may include the corresponding security tool having a cavity to receive the cap and flange of the fastener body and having a corresponding keyed security element to engage the keyed security drive feature on the fastener body.

According to one other embodiment, a security fastener assembly is provided with a cap having a decorative bearing surface and a lower retention portion. The security fastener also includes a fastener body having: a threaded portion or securing the fastener assembly to a corresponding threaded feature on a vehicle; a stem opposite the threaded portion for receiving the cap, the stem having a security protrusion defining a distal end, an undercut formed adjacent the stem for cooperating with the lower retention portion of the cap, where the lower retention portion of the cap is secured in the undercut to maintain the cap on the fastener body; a keyed security drive feature formed between the threaded portion the stem portion where the fastener body is removable with the keyed security feature. Engaging the decorative bearing surface of the cap and rotating does not rotate the threaded portion of the fastener body.

In another embodiment, the security fastener assembly is provided with security fastener assembly where the cap is secured to cap with a cold-working process to deform the lower retention portion into the undercut.

In another embodiment, the cold-working process applies an inward radial force to deform the lower retention portion into the undercut such that an inner surface of the cap faces an outer surface of the undercut.

In another embodiment, the cold-working process forms a swage location to deform the lower retention portion into the undercut continuously along at least a portion of the circumference of the undercut.

In another embodiment, the swage location extends continuously along a majority of the circumference of the undercut.

In another embodiment, the undercut may include an angled groove having an asymmetric cross-section.

In another embodiment, the security protrusion may include a conical surface.

In another embodiment, the security protrusion may include a circular cylinder with a circular inner opening.

In another embodiment, the circular cylinder has a plurality of flat portions spaced apart along an outer circumference by circular cylinder portions, where an inner surface of the cap contacts the security protrusion only along the circular cylinder portions.

In another embodiment, the circular cylinder has a thin wall having a thickness less than a radial depth of the undercut. The security fastener assembly may include a washer secured to the fastener body.

According to one other embodiment, a method of forming a fastener is provided. The method includes providing a fastener body having a threaded portion and a stem protrusion defining a distal end opposite the threaded portion, where an undercut is formed below the stem protrusion, and where a keyed security drive feature is formed between the threaded portion and the stem portion for engagement by a corresponding security drive tool. A cap having a standard tool bearing surface and a lower retention portion is also provided. The cap is placed on the fastener body to cover the stem protrusion. The method also includes cold-working the cap to deform the lower retention portion into the undercut thereby retaining the cap on the fastener body.

In another embodiment of the method, the cold-working may include applying an inward radial force with a tool to deform the lower retention portion into the undercut such that an inner surface of the cap faces an outer surface of the undercut.

In another embodiment of the method, cold-working may include swagging the lower retention portion into the undercut continuously along at least a portion of the circumference of the undercut.

### BRIEF DESCRIPTION OF THE DRAWINGS

FIG. 1 is a side view of a decorative security fastener assembly having a decorative cap and a fastener body according to one embodiment.

FIG. 2 is a side view of the security fastener assembly of FIG. 1 shown in a section view of a mounting location and shown in use with an installation tool.

FIG. 3 is a top perspective view of the fastener body of the security fastener assembly in FIG. 1.

FIG. 4 is a top-side perspective view of a decorative security fastener assembly having a decorative cap and a fastener body according to another embodiment.

FIG. 5 is a section view of the decorative security fastener according to another embodiment.

FIG. 6 is a top perspective view of the fastener body of the security fastener assembly in FIG. 5 shown with the cap removed.

FIGS. 7-9 are detailed views of the cap and retention feature on the fastener body according to various embodiments.

FIG. 10 is a side section view of the fastener body with a cap removed according to another embodiment.

FIG. 11 is a top view of a fastener assembly with the fastener body of FIG. 10.

FIG. 12 is a top view of the fastener assembly in FIG. 11 with the cap installed.

FIG. 13 is a side section view of a fastener body with a cap removed according to another embodiment.

FIG. 14 is a side section view of the fastener body in FIG. 13.

FIG. 15 is a side section view of a fastener assembly according to another embodiment.

FIG. 16 is a side view of a fastener assembly according to another embodiment.

FIG. 17 is a side section view of the fastener assembly in FIG. 16.

FIG. 18 is a partial section view of a fastener assembly according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The application relates to security wheel fasteners that have the same styling, tension and friction performance as the existing wheel fasteners.

Available security fasteners may not have matching styling, size, form, or fit of existing wheel fasteners. Available security fasteners also may not meet tension and friction requirements of existing wheel fasteners.

A decorative security fastener deters the theft of automotive wheels, through performing as a security fastener, without sacrificing styling or performance of the original equipment wheel fastener.

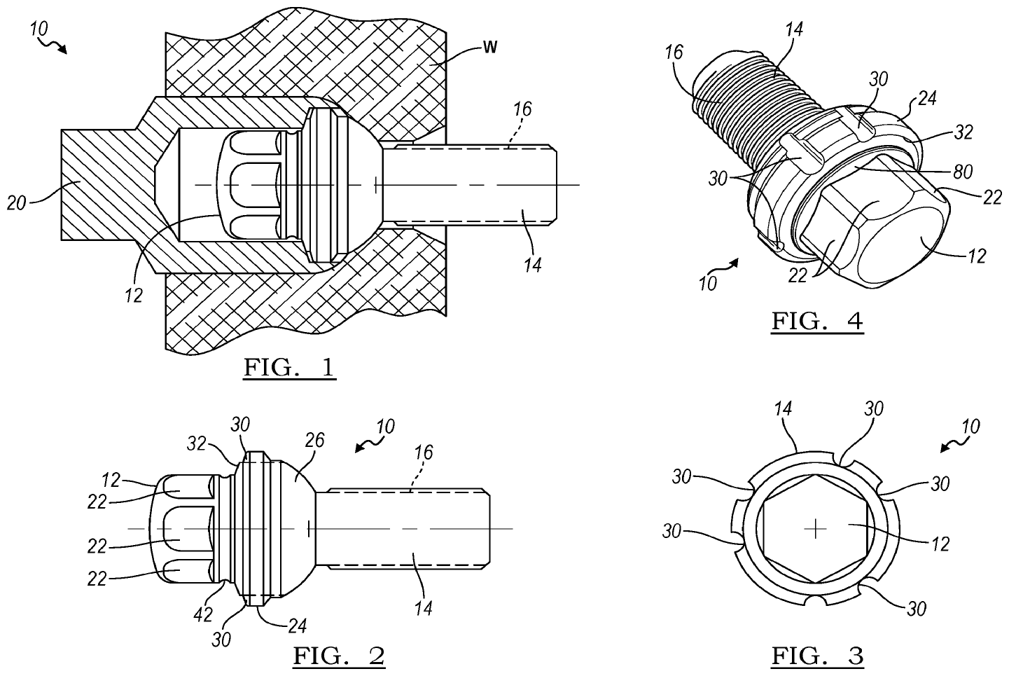

FIG. 1 is side view of the decorative security fastener assembly 10 shown in a section view of a mounting location and shown in use with an installation tool 20. FIGS. 2-3 show the side view and top view of the decorative security fastener 10 in more detail and having a decorative cap 12 and a fastener body 14.

The decorative security fastener 10 has a threaded portion 16 with internal or external threads. As shown in the Figures, the decorative security fastener 10 may be a bolt having external threads. The decorative wheel fastener may also be formed as a nut with internal threads. The decorative wheel fastener 10 matches the styling and performance of a standard wheel fastener. For example, the decorative security fastener assembly 10 includes a decorative fastener cap 12 coupled to a security fastener body 14. The fastener cap 12 has a wrenching surface 22 being common with the wrenching surfaces of other wheel fasteners on the vehicle. As shown in the Figures, the decorative fastener cap 12 may have a hexagonal wrenching surface 22. The cap 12 may have six wrenching surfaces oriented in a hexagonal shape. However, it is possible for the cap 12 to have a different polygonal shape with a different number of wrenching surfaces or, any suitable shape, configuration or standard of tool wrenching surface may be used. For example, a fastener cap having a three-pointed tool wrenching surface may be used, such as U.S. patent application Ser. No. 15/487,805 by Larry Wilson et al., or a hybrid wrenching surface, such as in U.S. patent application Ser. No. 15/872,386 by Steven Tomaszewski et al., the disclosures of which are hereby incorporated by reference herein.

The threaded portion 16 of the fastener body 14 has standard thread specifications allowing for standard torque specifications. However, while the decorative cap 12 appears the same as a standard fastener, when the cap is engaged by a standard tool, the cap 12 would spin freely or rotate without affecting the threaded portion and clamping forces.

The decorative security fastener is installed and removed using a special matching tool 20 that engages on the keyed security drive feature 30. The matching keyed security tool 20 is required to remove the fastener body 14 from the wheel W and the drive feature 30 is not able to be gripped by a standard tool to apply enough torque to remove the fastener body 14. As shown, the keyed security drive feature 30 may be formed on a flange 24 of the fastener body and may be formed as a plurality of security notches formed along the periphery of the flange 24. The plurality of notches 30 may have any suitable shape, number or spacing along the flange 24. Alternatively, the keyed security drive feature 30 may be formed as a unique shaped recess on the top surface 32 of the flange 24 or other portion of the fastener body 14. The security drive feature 30 may have different undulating, serpentine, irregular or unique shaped recess, or plurality of recesses that are not able to be gripped by a standard tool to transmit sufficient torque to unseat the fastener body 14 from the vehicle. The security drive feature 30 may be positioned in various locations on the fastener body 14 in combination with the decorative cap 12 as discussed in International Application No. PCT/US20/66090 filed Dec. 18, 2020, and U.S. provisional application Ser. No. 62/950,096 filed Dec. 18, 2019, the disclosures of which are hereby incorporated in their entirety by reference herein.

The fastener body 14 may also have a tapered, spherical or frustoconical bearing surface 26 that is formed between the flange 24 and the threaded portion 16. The bearing surface 26 may also be defined by a washer in combination with the fastener body. When the threads are fully seated at standard torque levels, the bearing surface 26 may be compressed and in tension with a corresponding surface to reduce the tendency for the bolt to loosen, thereby maintaining the fastener 10 securely seated. The fastener body may have a coating, or multi-layer coatings, that provide corrosion resistance and also provide a desired coefficient of friction. For example, the fastener body may have a coating such as described in U.S. patent application Ser. No. 17/716,979, the disclosure of which is hereby incorporated in its entirety by reference herein.

The cap 12 has a decorative wrenching surface that matches the size and styling of the existing wheel fasteners. The cap 12 will rotate separately to the fastener and will not remove the fastener or affect tension in the joint. The cap may be secured to the fastener body after any coating is applied to the fastener body so the cap does not have a coating or has a coating different than the fastener body. For example, the cap 12 may be formed of stainless steel and may be polished, and not require additional coatings. The cap 12 may also have a decorative coating, such as black coating as described in International Patent Application No. PCT/US22/22811 by MacLean Fogg Company, the disclosure of which is hereby incorporated by reference herein.

As shown in the Figures, the decorative cap 12 may have a decorative hexagonal shape to have the same styling as standard hexagonal fasteners. The cap 12 is formed of metal, such as stainless steel. By forming the cap 12 of metal, the cap will have the same aesthetic and durability of the standard fasteners. The cap 12 may also have a decorative finish and can be bright, black, variations of DLC colors, and have logos and/or branding etched and/or annealed onto the exposed surfaces. A decorative cap 12 can match the styling of the existing wheel fasteners that can be customized with different finishes, colors, logos, and branding.

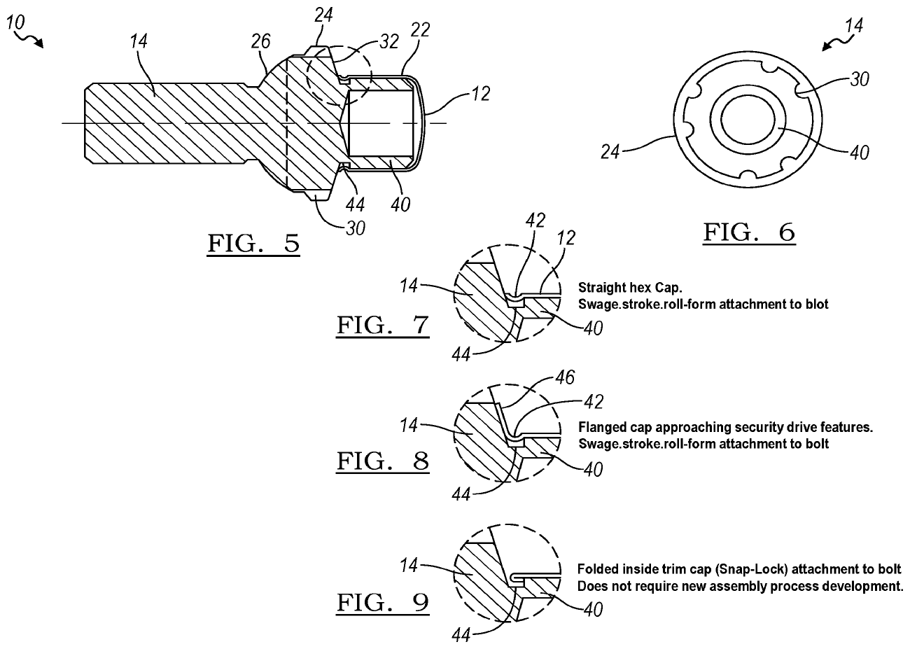

The decorative cap 12 is placed over a stem 40 on the fastener body 14. The stem 40 defines a security protrusion shaped to prevent a standard tool or an extractor tool from being able to grip or engage the security protrusion to apply torque to remove the fastener from the wheel if the cap is removed. The geometry of the security protrusion of the stem 40 may have several different configurations. As shown in FIGS. 5-6, the stem 40 may be round forming a circular cylinder protrusion that extends from the flange 24 of the fastener body 14. The stem 40 may generally be the same size as the inside dimension of the polygon shaped decorative cap 12. The inside shape of the cap 12 is different than the outer shape of the stem 40. The different shapes provide reduced contact surface between the cap 12 and the stem 40 and allow the cap to rotate relative to the fastener body 14. A polygon shaped cap is fitted to the fastener stem 40 so that the cap 12 will rotate when a torque that is less than the torque necessary to loosen the fastener is applied.

FIG. 5 is a section view of the decorative security fastener like that shown in FIGS. 1-4 according to one embodiment. FIG. 6 is a top perspective view of the fastener body of the security fastener assembly in FIG. 5 shown with the cap removed.

The decorative cap 12 may be attached to the fastener body 14 with various attachment methods that displace a lower retention portion 42 of the cap 12 into a retention feature 44 on the fastener body 14. The retention feature 44 retains the cap 12 to the fastener body 14 while still allowing the cap 12 to rotate relative to the fastener body 14. As shown in detail in FIGS. 7-9, the retention feature 44 has a diameter and width that is less than the stem 40 of the fastener body 14 and forms a groove, or undercut, for example.

As shown in FIGS. 7-8, the decorative cap 12 may be attached to the retention feature 44 by various attachment methods such as swagging, crimping, staking, rolling, metal working tooling and machine tools that displace the lower portion of the cap into the retention feature 44 on the fastener body 14. The cap forming methods may allow the cap attachment method feature to be a separate manufacturing process, or part of the fastener forming process. For example, the retention feature 44 adjacent the fastener stem, or formed as part of the stem, allows displacement of the cap by swagging, crimping, staking, rolling, or other forms of metal cold-working, in order to secure the cap to the fastener.

The decorative cap 12 may be attached to the fastener body 64 with various attachment methods that displace a lower retention portion 42 of the cap 12 into a retention feature 44 on the fastener body 64. The attachment methods or manufacturing process may use compressive forces to deform the cap 12 along the lower retention portion 42. The manufacturing method may shape or deform the lower retention portion 42 inward into the undercut or groove to create an attachment joint that retains the cap 12 to the fastener body 14 with a process such as swagging, stacking, crimping, roll-forming or other cold-working or forging process. The attachment joint may allow the cap 12 to rotate relative to the fastener body 14. As shown in detail in FIG. 4, the decorative cap 12 may be attached to the retention feature 44 by crimping the cap 12 into the retention feature 44 on the fastener body 64 along each of the flat portions 72. Therefore, in the embodiment illustrated, the cap 12 is crimped to the fastener body 64 in three places adjacent each of the flat portions 72 of the stem 70. The crimping process includes applying a radial force to the cap 12. For example, as shown in FIG. 4, the cap 12 may be crimped in up to in three crimp-locations 80, however, any number of crimp locations may be provided.

The cap 12 may be retained to the fastener body 10 by swagging or forming the cap to the fastener body continuously along the circumference of the undercut retention feature 44. The cap forming methods may allow the cap attachment method feature to be a separate manufacturing process, or part of the fastener forming process. As shown in FIG. 7, the cap 12 may be a straight cap that has a swage, stake, roll-form, crimp or other suitable attachment method to the cap. As shown in FIG. 8, the lower retention portion 42 of the decorative cap 12 may have an extended shoulder 46 that extends toward the security drive feature.

Some cap forming methods allow the cap shoulder to engage into the retention feature 44 on the fastener body 14 during cap assembly without requiring crimping, staking, rolling, metal working tooling and machine tools to displace a portion of the cap. As shown in FIG. 9, a folded portion 48 of the cap 12 may be created that will engage into the retention feature 44 on the fastener body 14 with an interference fit such as a snap-fit or snap-lock. For example, the lower retention portion 42 of the cap 12 may engage the retention feature 44 on the fastener body 12 with an interference fit. The folded portion 48 may be formed with the cap 12 and may not require a separate process to attach the cap 12 to the fastener body 14, such as swagging, crimping, staking, rolling, metal working tooling and machine tools to displace a portion of the cap.

The retention feature 44 of the fastener body 14 can also act as a breakaway feature where the stem 40 detaches from the fastener body 14 under excess force. When the stem 40 detaches it prevents removal of the fastener if a thief manages to pry away the rotating cap then wants to try and use an easy out fastener removal tool.

The installation and removal tool 20 can be designed to not damage wheel surfaces. The tool has a cavity to receive the cap 12 and flange 24 of the fastener body 14, as shown in FIG. 1. The tool 20 has a corresponding keyed security element to engage the keyed security drive 30 on the fastener body 14. For example, the corresponding keyed security elements may be pin or protrusion that engages the grooves on the flange 24 of the fastener body 14. As shown in FIG. 1, the tool 20 may bottom on the flange 24 but have no contact with the wheel. The tool 20 may have a clearance to the wheel of 1 mm, for example.

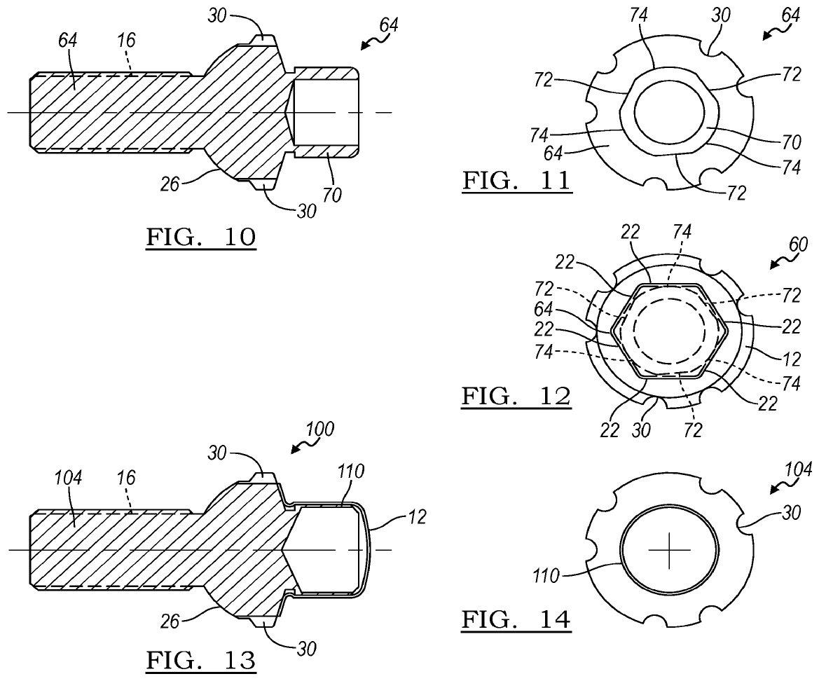

FIGS. 10-12 illustrate a decorative security fastener assembly 60 having a fastener body 64 according to another embodiment. The security fastener 60 may use the decorative cap 12, as discussed above. The decorative security fastener 60 has a threaded portion 16 with internal or external threads. As shown in the Figures, the decorative security fastener 60 may be a bolt having external threads. The decorative wheel fastener may also be formed as a nut with internal threads. The decorative wheel fastener 60 matches the styling and performance of a standard wheel fastener and includes the decorative fastener cap 12 coupled to the security fastener body 64.

The decorative cap 12 is placed over a stem 70 the forms a protrusion on the fastener body 64. As shown in FIGS. 10-12, the stem 70 may have flat portions 72 and arc segments 74. The arc segments 74 may be tangential to flats sides on the cap 12, such as hexagonal sides, as shown in FIG. 12. The flat portions 72 reduce the material or the weight and may provide material cost savings as well as lightweighting of the fastener. The inside shape of the cap 12 only contacts the stem 70 along the arc segments 74 so the cap 12 spins freely with little friction so that the cap 12 will rotate when a torque that is less than the torque necessary to loosen the fastener is applied.

The threaded portion 16 of the fastener body 64 has standard thread specifications allowing for standard torque specifications. However, while the decorative cap 12 appears the same as a standard fastener, when the cap is engaged by a standard tool, the cap 12 would spin freely or rotate without affecting the threaded portion and clamping forces.

FIGS. 13-14 illustrate a decorative security fastener assembly 100 having a fastener body 104 according to another embodiment. The security fastener 100 may use the decorative cap 12, as discussed above.

The decorative cap 12 is placed over a stem 110 on the fastener body 104. As shown in FIGS. 13-14, the stem 110 may have thin side walls 112. The stem 110 may crumple or deform if a torque that is less than the fastener breakaway clam load is applied to the stem 110.

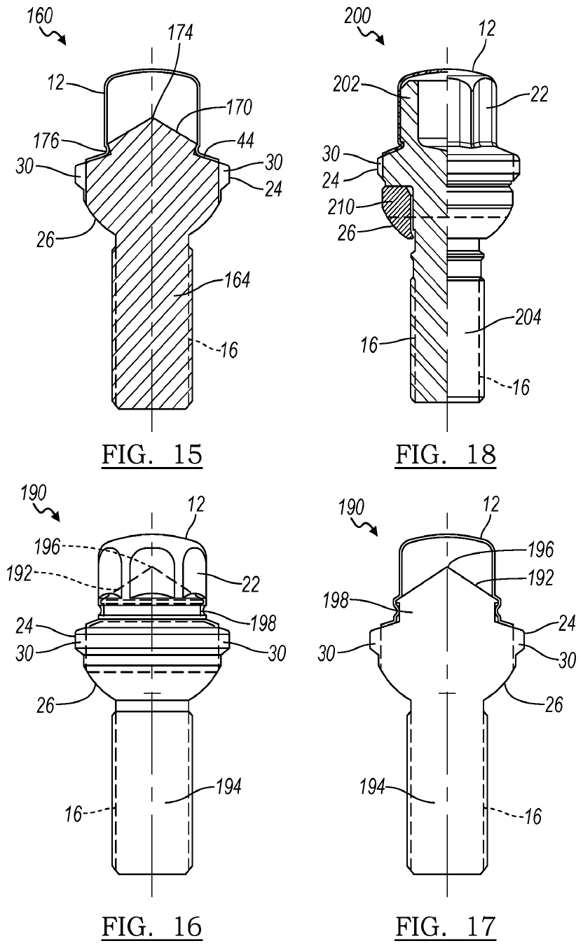

FIG. 15-17 illustrate decorative security fastener assemblies with a fastener body and stem according to other embodiments. As shown, the stem may have a distal end being sloped or pointed. The protrusion formed by the stem has insufficient length and is too short for gripping by an extractor or removal tool. In addition, the distal end does not provide a surface that can easily be engaged by a screw-extractor tool, such as an easy-out tool. The protrusion may be a domed surface, a conical surface, or other shaped surface that slopes away from a distal end.

In FIG. 15, a fastener assembly 160 has a fastener body 164 with the stem 170 with protrusion having a pointed distal end 174 having a conical surface. The security fastener 160 may use the decorative cap 12, as discussed above. The decorative cap 12 is placed over the stem 170 on the fastener body 164. The lower retention portion 64 is deformed inward into an undercut 176 being an angled groove and asymmetrical. As shown, the undercut 176 extends at an angle from the base of the conical surface. The undercut 176 is formed below the conical stem and has a radius and/or diameter less than a base of the stem 170.

FIGS. 16-17 illustrate a fastener assembly 190 having a fastener body 194 with the stem 192 with protrusion having a pointed distal end 196 having a conical surface. An undercut 198 is defined by a groove that is generally symmetrical in the axial direction. The undercut 198 may be taller to define a larger groove between the stem 170 and the flange 24. For example, the undercut 198 may have a dimension of 2-4 mm, or larger. The security fastener 190 may use the decorative cap 12, as discussed above. The undercut 198 may allow for the cap to be deformed inward by swagging the cap 12 around a majority of the circumference at the undercut 198.

FIG. 18 illustrates a fastener assembly 200 according to another embodiment. The fastener assembly has a fastener body 204 with a stem 202. The stem 202 may have a protrusion forming the distal end that is cylindrical, conical, or other suitable shape. The security fastener 200 also has a washer 210. The washer 210 is positioned between the flange 24 and the threaded portion 16 and defines the bearing surface 26. The washer 210 abuts the flange 24 and may be compressed and in tension with a corresponding surface in the wheel to reduce the tendency for the bolt to loosen, thereby maintaining the fastener assembly 200 securely seated. The washer 210 may rotate on the fastener body 204. As discussed above, the fastener body 204 has a keyed security feature 30 formed along the flange 24. The security fastener assembly 200 may use the decorative cap 12 that can be cold-worked and deformed to be retained on the fastener body 204 in a retention feature 44 such as an undercut, as discussed above.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A security fastener assembly comprising:
a cap shaped with a standard tool bearing surface and a lower retention portion;
a fastener body having:
a threaded portion or securing the fastener assembly to a corresponding threaded segment on a vehicle;
a conical stem opposite the threaded portion and defining a distal end, wherein the cap conceals the conical stem,
an undercut formed below the conical stem and having a radius less than a base of the conical stem, wherein the lower retention portion of the cap is deformed inward into the undercut with a cold-working process to maintain the cap on the fastener body; and
a keyed security drive feature formed between the threaded portion and the conical stem and not concealed by the cap for engagement by a corresponding security tool,
wherein rotating the cap does not rotate the threaded portion of the fastener body, wherein the fastener body is removable from the corresponding threaded segment with the keyed security feature.

2. The security fastener assembly of claim 1, wherein the lower retention portion is swagged to deform the lower retention portion into the undercut continuously along at least a portion of the circumference of the undercut.

3. The security fastener assembly of claim 1, wherein the cold-working processes forms a plurality of retention locations that deform the lower retention portion into the undercut at each of the plurality of retention locations.

4. The security fastener assembly of claim 1, further comprising the corresponding security tool having a cavity to receive the cap and flange of the fastener body and having a corresponding keyed security element to engage the keyed security drive feature on the fastener body.

5. A security fastener assembly comprising:
a cap having a decorative bearing surface and a lower retention portion;
a fastener body having:
a threaded portion or securing the fastener assembly to a corresponding threaded feature on a vehicle;
a stem opposite the threaded portion for receiving the cap, the stem having a security protrusion defining a distal end,
an undercut formed adjacent the stem for cooperating with the lower retention portion of the cap, wherein the lower retention portion of the cap is secured in the undercut to maintain the cap on the fastener body;
a keyed security drive feature formed between the threaded portion the stem portion wherein the fastener body is removable with the keyed security feature,
wherein engaging the decorative bearing surface of the cap and rotating does not rotate the threaded portion of the fastener body.

6. The security fastener assembly of claim 5, wherein the cap is secured to cap with a cold-working process to deform the lower retention portion into the undercut.

7. The security fastener assembly of claim 6, wherein the cold-working process applies an inward radial force to deform the lower retention portion into the undercut such that an inner surface of the cap faces an outer surface of the undercut.

8. The security fastener assembly of claim 7, wherein the plurality of retention locations comprises at least three crimp locations.

9. The security fastener assembly of claim 5, wherein the cold-working process forms a swage location to deform the lower retention portion into the undercut continuously along at least a portion of the circumference of the undercut.

10. The security fastener assembly of claim 9, wherein the swage location extends continuously along a majority of the circumference of the undercut.

11. The security fastener assembly of claim 5, wherein the undercut comprises an angled groove having an asymmetric cross-section.

12. The security fastener assembly of claim 5, wherein the security protrusion comprises a conical surface.

13. The security fastener assembly of claim 5, wherein the security protrusion comprises a circular cylinder with a circular inner opening.

14. The security fastener assembly of claim 13, wherein the circular cylinder has a plurality of flat portions spaced apart along an outer circumference by circular cylinder portions, wherein an inner surface of the cap contacts the security protrusion only along the circular cylinder portions.

15. The security fastener assembly of claim 13, wherein the circular cylinder has a thin wall having a thickness less than a radial depth of the undercut.

16. The security fastener assembly of claim 5, further comprising a washer secured to the fastener body.

17. A method of forming a fastener comprising:
providing a fastener body having a threaded portion and a stem protrusion defining a distal end opposite the threaded portion, wherein an undercut is formed below the stem protrusion, and wherein a keyed security drive feature is formed between the threaded portion and the stem portion for engagement by a corresponding security drive tool;
providing a cap having a standard tool bearing surface and a lower retention portion;
placing the cap on the fastener body to cover the stem protrusion;
cold-working the cap to deform the lower retention portion into the undercut thereby retaining the cap on the fastener body.

18. The method of claim 17, wherein the cold-working comprises applying an inward radial force with a tool to deform the lower retention portion into the undercut such that an inner surface of the cap faces an outer surface of the undercut.

19. The method of claim 17, wherein the cold-working comprises swagging the lower retention portion into the undercut continuously along at least a portion of the circumference of the undercut.

20. The method of claim 17, wherein the cold-working comprises crimping the lower retention portion into the undercut at each of the plurality of retention locations.
